(19) United States
(12) Patent Application Publication
(10) Pub. No.: US 2024/0217316 A1
(43) Pub. Date: Jul. 4, 2024

(54) VEHICLE AWNING

(71) Applicant: Rivian IP Holdings, LLC, Plymouth, MI (US)

(72) Inventors: Thomas Stevenson, Warwickshire (GB); Neil Joseph Kwiatkowski, Costa Mesa, CA (US); Mary Elizabeth Mossey, Costa Mesa, CA (US); William Kirk Robinson, Irvine, CA (US); Matthew Matera, Newport Beach, CA (US)

(21) Appl. No.: 18/164,198

(22) Filed: Feb. 3, 2023

Related U.S. Application Data
(60) Provisional application No. 63/477,922, filed on Dec. 30, 2022.

(51) Int. Cl. B60J 3/00; B60J 11/04; B60R 9/055

(52) U.S. Cl. CPC B60J 3/002; B60J 11/04; B60R 9/055

(57) ABSTRACT

An apparatus that can include a case, and a beam. The case can stow a canopy. The case can also couple with a crossbar. The beam can be coupled with the case. The beam can deploy the canopy.

### CROSS-REFERENCE TO RELATED PATENT APPLICATIONS

This application claims the benefit of and priority to U.S. Provisional Patent Application No. 63/477,922 filed on Dec. 30, 2022, the entirety of which is incorporated by reference herein.

### INTRODUCTION

Vehicles can park in indoor or outdoor environments, adjacent to surrounding external areas.

### SUMMARY

This disclosure is generally directed to an apparatus for a vehicle. The apparatus can be or include an awning. The awning can include a case and the case can house a canopy. The apparatus can be coupled with or included with the vehicle. The awning can be coupled with the vehicle without the use of tools. The canopy housed with the case can be deployed to a position that is external the case. The canopy can provide shelter or shade from the elements. For example, the canopy can provide shade from the sun. The canopy can include modular panels that can be deployed to a secondary position with respect to the position of the canopy.

At least one aspect is directed to an apparatus. The apparatus can include a case. The case can stow a canopy. The case can also couple with a crossbar. The apparatus can also include a beam. The beam can be coupled with the case. The beam can deploy the canopy.

At least one aspect is directed to a vehicle. The vehicle can include a crossbar. The vehicle can also include an apparatus. The apparatus can include a case. The case can stow a canopy. The case can be coupled with the crossbar. The apparatus can also include a beam. The beam can be coupled with the case. The beam can deploy the canopy.

At least one aspect is direct to a method of manufacturing an apparatus. The method can include coupling a case with a beam. The case can stow a canopy. The case can be coupled with a crossbar. The beam can deploy the canopy.

At least one aspect is directed to an apparatus. The apparatus can include a case. The case can be coupled with a crossbar of a vehicle. The case can also include a wall. The apparatus can also include a canopy. The canopy can be coupled with the case. The apparatus can also include a beam. The beam can be coupled with the canopy and the beam can be coupled with the case. The beam can also stow the canopy in a first position. The beam can also deploy the canopy to a second position.

At least one aspect is directed to a vehicle. The vehicle can include a crossbar and an apparatus. The apparatus can include a case. The case can be coupled with the crossbar. The case can also include a wall. The apparatus can also include a canopy. The canopy can be coupled with the case. The apparatus can also include a beam. The beam can be coupled with the canopy and the beam can be coupled with the case. The beam can also stow the canopy in a first position. The beam can also deploy the canopy to a second position

At least one aspect is directed to a method of manufacturing an apparatus. The method can include coupling a canopy with a case. The case can be coupled with a crossbar of a vehicle. The method can also include coupling a beam with the canopy and the case. The beam can stow the canopy in a first position, and the beam can deploy the canopy to a second position.

At least one aspect is directed to a method of manufacturing an apparatus. The method can include disposing a canopy within a case. The case can include a wall. The case can be coupled with a crossbar of a vehicle. The method can also include coupling a beam with the canopy and the wall. The beam can deploy the canopy.

At least one aspect is directed to a method. The method can include providing an apparatus. The apparatus can include a case. The case can be coupled with a crossbar of a vehicle. The apparatus can also include a canopy. The canopy can be coupled with the case. The apparatus can also include a beam. The beam can be coupled with the case and the beam can be coupled with the canopy. The beam can stow the canopy in a first position, and the beam can deploy the canopy to a second position.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle.

FIG. 2 depicts a front view of an apparatus, in accordance with an implementation.

FIG. 3 depicts a side view of a vehicle including the apparatus illustrated in FIG. 2, in accordance with an implementation.

FIG. 4 depicts a side view of a vehicle including the apparatus illustrated in FIG. 2, in accordance with an implementation.

FIG. 5 depicts a side view of a vehicle including the apparatus illustrated in FIG. 2, in accordance with an implementation.

FIG. 6 depicts a side view of a vehicle including the apparatus illustrated in FIG. 2, in accordance with an implementation.

FIG. 7 depicts a rear view of a vehicle including the apparatus illustrated in FIG. 2, in accordance with an implementation.

FIG. 8 depicts a perspective view of a vehicle including the apparatus illustrated in FIG. 2, in accordance with an implementation.

FIG. 9 depicts a top view of a vehicle including the apparatus illustrated in FIG. 2, in accordance with an implementation.

FIG. 10A depicts a rear view of a vehicle receiving the apparatus illustrated in FIG. 2, in accordance with an implementation.

FIG. 10B depicts a rear view of a vehicle including the apparatus illustrated in FIG. 2, in accordance with an implementation.

FIG. 11 depicts a rear view of a vehicle including a crossbar coupled with the apparatus illustrated in FIG. 2, in accordance with an implementation.

FIG. 12 depicts a side view of a vehicle including a crossbar coupled with the apparatus illustrated in FIG. 2, in accordance with an implementation.

FIG. 13 depicts a rear view of a vehicle including a tailgate coupled with a canopy, in accordance with an implementation.

FIG. 14 depicts a top view of a strap, in accordance with an implementation.

FIG. 15 depicts a bottom view of a canopy including an electrical port, in accordance with an implementation.

FIG. 16 depicts a bottom view of a canopy including panels, and light fixtures, in accordance with an implementation.

FIG. 17 depicts a front view of an enclosure for at least one hinge, in accordance with an implementation.

FIG. 18 depicts a side view of a spine for the apparatus illustrated in FIG. 2, in accordance with an implementation.

FIG. 19 depicts a side view of a vehicle including a gear tunnel, in accordance with an implementation.

FIG. 20 depicts an example system to control an apparatus, in accordance with an implementation.

FIG. 21 depicts an example flow diagram of a process of manufacturing an apparatus, in accordance with an implementation.

FIG. 22 depicts an example flow diagram of a process to provide an apparatus, in accordance with an implementation.

FIG. 23 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of providing a vehicle awning. The various concepts introduced above and discussed in greater detail below may be implemented in any of numerous ways.

The present disclosure is directed to systems and methods of providing an apparatus. The apparatus can be or include an awning. The awning can include a canopy. The canopy can be housed, disposed or located in a case. The canopy can be deployed to a position that is external to the case. The canopy can provide shade and shelter from the elements. The canopy can be coupled with a beam, and the beam can couple the canopy with a wall of the case. The beam can couple the canopy with the wall at a first position of the wall. The case can include at least one strap. The straps can be coupled with a second position of the wall. The straps can couple the canopy with the wall at the second position of the wall. The straps can secure the canopy, responsive to the straps coupling the canopy to the wall, in a stowed position.

The disclosed solutions have a technical advantage of providing a modular awning that can be coupled and decoupled from a vehicle. The apparatus can include brackets. The brackets can provide a tool less coupling and decoupling experience. The positioning of the canopy with respect to the vehicle can be adjusted, changed or otherwise altered. For example, the canopy can provide shade to a first area near or around the vehicle, and the canopy can be moved separate from the vehicle to provide shade to a second area near or around the vehicle.

Systems and methods of the present technical solution can provide an apparatus. The apparatus can include a deployable and stowable canopy. The canopy can be stowed within (e.g., a stowed position) a case of the apparatus and the canopy can be deployed to a position external (e.g., a deployed position) to the case. The canopy can be deployed and stowed without any tools, and the canopy can have at least one configurable panel. The configurable panels can deploy to a position that expands or adjusts the shelter provided by the canopy. For example, the canopy, responsive to being deployed to a position external the cased, can provide shelter from the elements (e.g., rain, snow or the wind). The configurable panels can be deployed to provide additional shelter or the configurable panels can be deployed responsive to a change in the elements (e.g., the rain is coming from a different directions, the wind is blowing in a different direction).

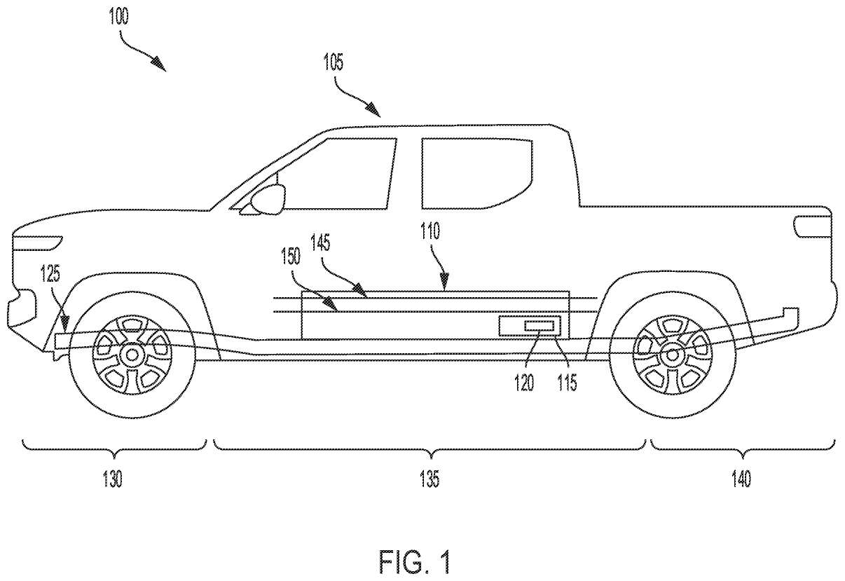

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

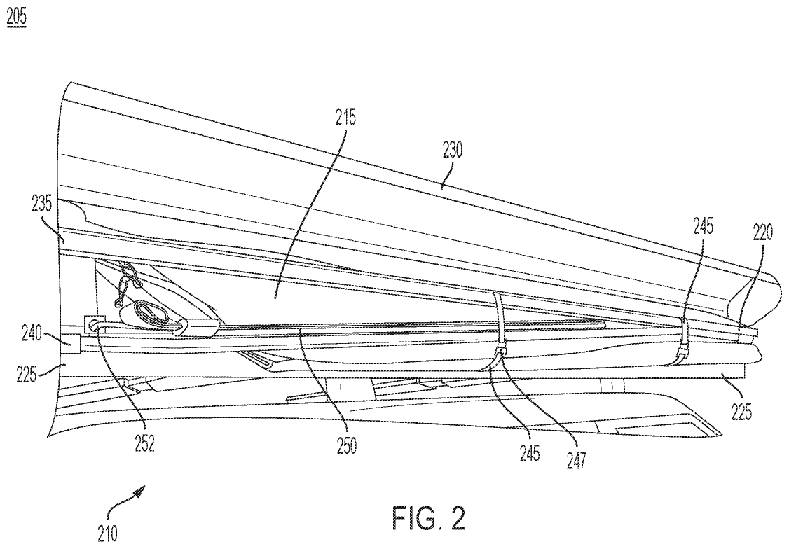

FIG. 2 depicts a front view of an apparatus 205, in accordance with an implementation. The apparatus 205 can include at least one case 210, at least one canopy 215, at least one beam 220, at least one first strap 245, and at least one second strap 250. The case 210 can be mounted, placed, secured, attached or otherwise coupled with a vehicle. For example, the case 210 can be coupled with a crossbar of the vehicle 105. The case 210 can include at least one wall 225, and at least one lid 230. The walls 225 can create, establish or otherwise define a housing for the canopy 215. The case 210 can stow the canopy 215. For example, the case 210 can stow the canopy 215 in the housing defined by the walls 225. The lid 230 can hinge, adjust, swivel, pivot or otherwise move from a first position to a second position. The first position can be a closed position or a shut position. The second position can be an opened position or an unclosed position. The lid 230 can enclose the canopy 215. For example, the lid 230 can enclose the canopy 215, responsive to the lid 230 being placed in the first position, within the housing defined by the wall 225. The lid 230 can enclose the canopy 215 by covering, surrounding, encompassing or otherwise confining the canopy 215 within the case 210. The lid 230 can provide access to the canopy 215. For example, the lid 230 can provide access to the canopy 215, responsive to the lid 230 being placed in the second position, by exposing, presenting or otherwise uncovering the canopy 215. FIG. 2 depicts an example of the lid 230 in the second position, and an example of the lid 230 providing access to the canopy 215.

The canopy 215 can be mounted, placed, secured, attached or otherwise coupled with at least one of the case 210 or the wall 225. For example, the canopy 215 can be coupled with a slot disposed within the wall 225. The canopy 215 can be or include at least one of an awning, a shade, a cover or a shelter. The canopy 215 can be at least one of polyester, nylon, cotton or other possible polyurethane material. The canopy 215 can provide shade or shelter from the elements or environment. For example, a person could stand underneath or near the canopy 215 and the canopy 215 can provide shade from the sun to the person standing underneath or near the canopy 215. The canopy 215 can have at least one configuration. For example, the canopy 215 can have a first configuration and a second configuration. The first configuration can be at least one of an unhindered, an unaffected or otherwise natural configuration. For example, the canopy 215 can be in the first configuration while the canopy 215 is drooping, dangling, suspended or otherwise hanging between a portion of the case 210 and a ground surface. The second configuration can be at least one of a rolled, tucked, bent or otherwise folded configuration. For example, the canopy 215 can be folded over itself. An operator of the apparatus 205 or the canopy 215 can fold, roll, tuck, bend or otherwise move the canopy 215 from the first configuration to the second configuration. The canopy 215 can, responsive to the operator placing the canopy 215 in the second configuration, be stowed in the first position. FIG. 2 depicts an example of the canopy 215 in the second configuration.

The beams 220 can be mounted, placed, secured, attached or otherwise coupled with the canopy 215. The beams 220 can be mounted, placed, secured, attached or otherwise coupled with at least one of the case 210 or the wall 225. For example, the beams 220 can be coupled with a side of the wall 225. The beam 220 can stow the canopy 215 in at least one first position. The first position (e.g., the stowed position) of the canopy 215 can be or include a position that is within the case 210. For example, the beam 220 can stow the canopy 215 in the case 210 (e.g., the first position) or within the housing defined by the walls 225. The beam 220 can deploy the canopy to at least one second position. The second position (e.g., the deployed position) of the canopy 215 can be or include a position that is external to the case 210. For example, the beam 220 can deploy the canopy 215 from the position within the case 210 (e.g., the first position) to a position that is external the case 210. The beams 220 can stow the canopy 215 within the case 210 responsive to an operator of the apparatus 205 or the vehicle 105 grabbing, interacting with, interfacing with or otherwise engaging with the beams 220. For example, the operator can grab the beams 220 and move the beams 220 from a position external to the case 210 to a position within the case 210. The beams 220 can, responsive to the operator moving the beams 220 to a position within the case 210, stow the canopy 215 in the first position. FIG. 2 depicts an example of the canopy 215 in the first position, and an example of the beam 220 having stowed the canopy 215 in the first position.

The beams 220 can include at least one first portion 235 and at least one second portion 240. The first portion 235 and the second portion 240 can be or include separate beams and the first portion 235 and the second portion 240 can couple with one another to form or create the beams 220. For example, the first portion 235 and the second portion 240 can be coupled with another at a first end of the beams 220. The first portion 235 and the second portion 240 can also be coupled with another, via a fastener, at a second end of the beams 220.

The straps 245 can be mounted, placed, secured, attached or otherwise coupled with the wall 225. The straps 245 can support, brace, secure or otherwise hold the canopy 215 in the first position. The straps 245 can also support, brace, secure or otherwise hold the canopy 215 in the first configuration. The straps 245 can include at least one fastener 247. The fastener 247 can be or include at least one of a clip, a latch, a clasp, a buckle, a pin or a hook. The fastener 247 can couple a first portion of the straps 245 with a second portion of the straps 245. The straps 245 can be adjusted, rearranged, reoriented or otherwise modified. For example, an operator of the apparatus 205 or the straps 245 can modify the straps 245 by tightening or loosening the straps 245 to adjust the amount of pressure that the straps 245 apply to the canopy 215. For example, the amount of pressure applied by the straps 245 to the canopy 215 can be increased by tightening the straps 245. Similarly, the amount of pressure applied by the straps 245 to the canopy 215 can be decreased by loosening the straps 245. FIG. 2 depicts an example of the straps 245 supporting the canopy 215 in the first position, and an example of the straps 245 holding the canopy in the second configuration.

The straps 250 can be mounted, placed, secured, attached or otherwise coupled with the beams 220. The straps 250 can be coupled with the beams 220 at first location and at a second location. At least one of the first location or the second location can be a permanent coupling (e.g., the straps 250 are not designed to decouple from the beams 220 at the first location or the second location). At least one of the first location of the second location can be a semi-permanent coupling (e.g., the straps are designed to decouple from the beams 220). FIG. 2 depicts an example of the permanent coupling location between the first portion 235 and the straps 250, and an example of the semi-permanent coupling location between the second portion 240 and the straps 250. For example, the straps 250 can decouple from the second portion 240 of the beams 220. The straps 250 can move the beams 220 and the canopy 215 from the first position to the second position. For example, an operator of the apparatus 205 or the vehicle 105 can interface with, interact with, engage or otherwise grab the straps 250. The operator can, responsive to grabbing the straps 250, move the beams 220 from the first position to the second position. Similarly, the operator can grab the straps 250 and move the beams 220 from the second position to the first position.

The straps 250 can include at least one fastener 252. The fastener 252 can be or include at least one of a clip, a latch, a clasp, a hook, a buckle or a lock. For example, the fastener 252 can be a Carabiner clip. The fastener 252 can mount, place, secure, attach or otherwise couple the straps 250 with a vehicle. For example, the fastener 252 can couple the straps 250 with the vehicle 105. The straps 250 can, responsive to the fastener 252 coupling the straps 250 with the vehicle 105, support the beams 220 with the canopy 215 in the second position. As described herein the canopy 215 can be deployed to a position that is external to the case 210 (e.g., the second position). The canopy 215 can, responsive to the beams 220 deploying the canopy 215 to the second position, cause the beams 220 to move towards the case 210. For example, the beams 220 can pivot from the second position to a position that is within the first position and the second position. The straps 250 can support the beams 220 in the second positon by at least one of holding, maintaining, locking or otherwise sustaining the beams 220 in the second position. For example, the straps 250 can couple with a tailgate of the vehicle 105 and the straps 250, responsive to coupling with the vehicle 105, can support the beams 220 by maintaining the beams 220 and the canopy 215 in the second position.

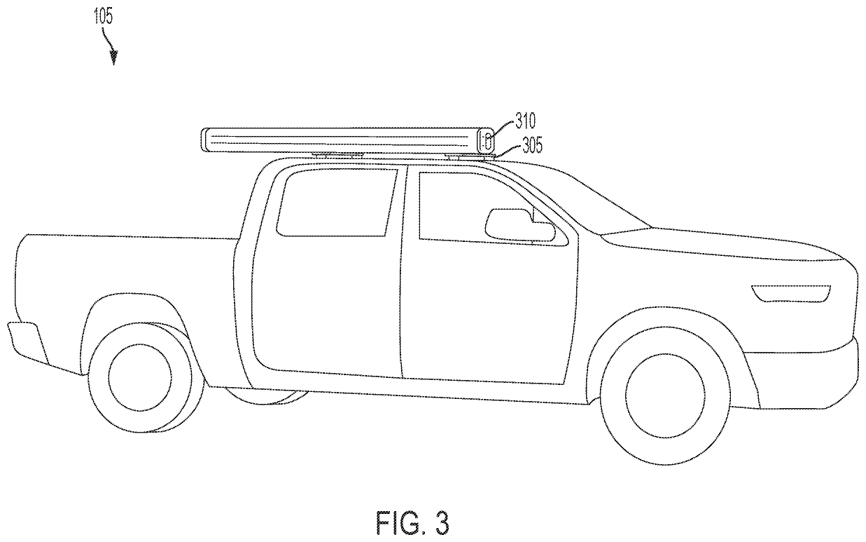

FIG. 3 depicts a side view of the vehicle 105 and the apparatus 205, in accordance with an implementation. The vehicle 105 can include at least one crossbar 305. The crossbar 305 can receive, accept or otherwise hold the apparatus 205 or a component thereof. The apparatus 205 can be mounted, placed, secured, attached or otherwise coupled with the crossbars 305. The crossbars 305 can mount, place, secure, attach or otherwise couple the apparatus 205 with the vehicle 105. The apparatus 205 can include at least one end cap 310. The end caps 310 can be mounted, placed, secured, attached or otherwise coupled with the lid 230. The end caps 310 can enclose, cover, obstruct or otherwise encompass a spine or inner portion of the walls 225. For example, the end caps 310 can prevent, by enclosing the inner portion of the walls, an object from entering the inner portion of the walls 225 with the lid 230 in the first position. FIG. 3 depicts an example of the apparatus 205 coupled with the crossbars 305, an example of the crossbar 305 coupling the apparatus 205 with the vehicle 105, an example of the lid 230 in the first position, an example of the lid 230 enclosing the canopy 215, an example of the end caps 310 enclosing the inner portion of the walls 225, and an example of the canopy 215 stowed within the case 210.

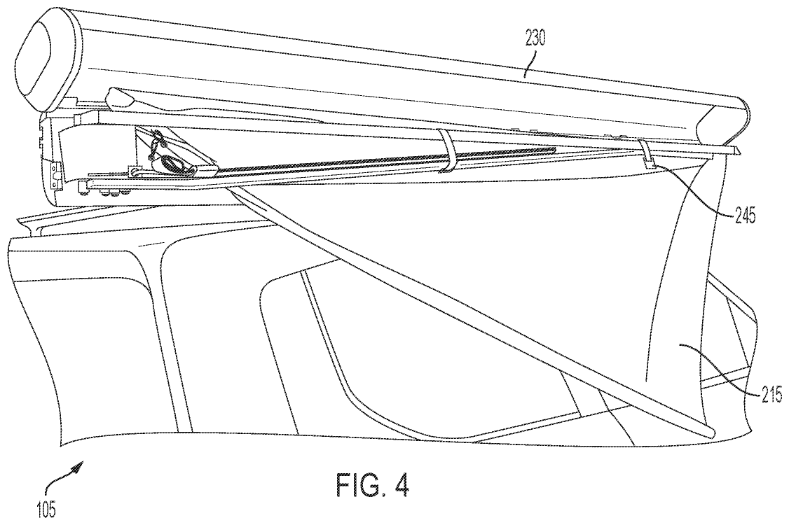

FIG. 4 depicts a side view of the vehicle 105 and the apparatus 205, in accordance with an implementation. The operator of the apparatus 205 or the vehicle 105 can interact with, interface with, engage or otherwise grab the lid 230 to move the lid 230 from the first position to the second position. The lid 230 can, responsive to the operator placing the lid 230 in the second position, provide the canopy 215. The operator of the apparatus 205 or the vehicle 105 can interact with, interface with, engage or otherwise grab the fastener 247 to decouple the first portion and the second portion of the straps 245. The canopy 215 can, responsive to the operator decoupling the first portion and the second portion of the straps 245, be placed in the first configuration. For example, the canopy 215 or a portion thereof can hang below a portion of the case 210. FIG. 4 depicts an example of the lid 230 in the second position, an example of the canopy 215 in the second configuration, an example of the first portion and the second portion of the straps 245 decoupled from one another, an example of the beams 220 stowed in the case 210, and an example of the apparatus 205 coupled with the vehicle 105.

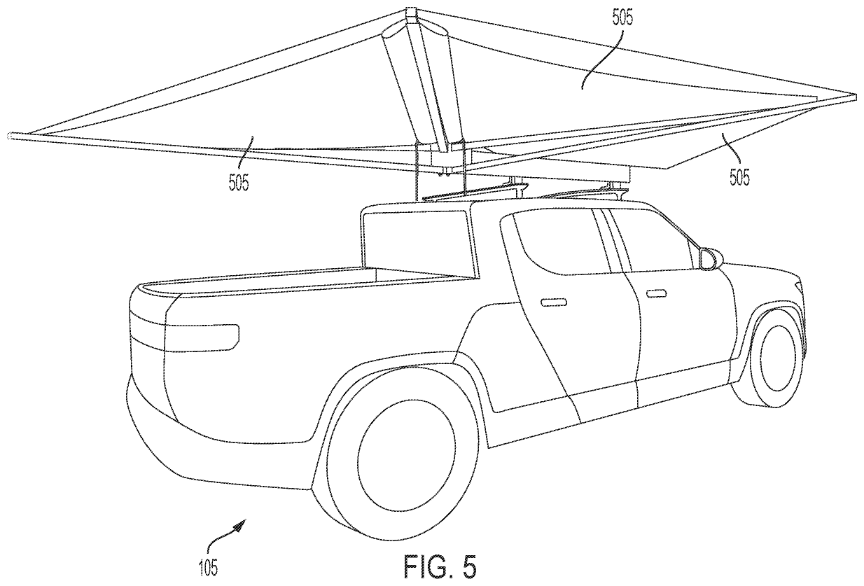

FIG. 5 depicts a side view of the vehicle 105 and the apparatus 205, in accordance with an implementation. The apparatus 205 can include at least one configurable panel 505. The configurable panel 505 can be mounted, placed, secure, attached or otherwise coupled with the canopy 215. The configurable panel 505 can be mounted, placed, secured, attached or otherwise coupled with at least one of the beams 220 or the walls 225. The configurable panels 505 can swing, rotate, pivot, swivel or otherwise move with or separate to the canopy 215. For example, the configurable panel 505 can move with the canopy 215 responsive to the canopy 215 moving from the first position to the second position. An operator of the apparatus 205 or the vehicle 105 can decouple the configurable panels 505 from the beams 220. The configurable panels 505 can, responsive to the operator decoupling the configurable panels 505 from the beams 220, dangle, droop, hang, drop or otherwise move separate from the canopy 215. For example, the canopy 215 and the configurable panels 505 can both be in the second position, and the configurable panels 505 can move from the second position to a third position responsive to the configurable panels 505 decoupling from the beams 220.

The configurable panels 505 can, responsive to decoupling from the beams 220, be deployed to a different position (e.g., the third position). The configurable panels 505 can adjust, modify, change or otherwise alter the amount or location of shade or shelter that is provided by the canopy 215. For example, the configurable panels 505 can, responsive to being placed in the third position, provide an additional amount of shade in relation to an amount of shade provided by the canopy 215, with both the canopy 215 and the configurable panels 505 in the second position. FIG. 5 depicts an example of the configurable panels 505 in the second position, an example of the configurable panels 505 coupled with the beams 220, an example of the beams 220 having been used to move the canopy 215 from the first position to the second position, and an example of the apparatus 205 coupled with the vehicle 105.

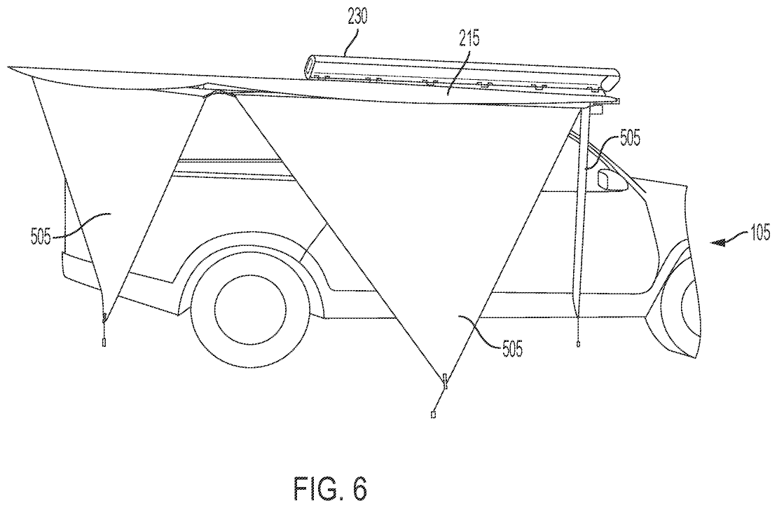

FIG. 6 depicts a side view of the vehicle 105 and the apparatus 205, in accordance with an implementation. FIG. 6 depicts an example of the configurable panels 505 having been decoupled from the beams 220, an example of the configurable panels 505 having moved from the second position to the third position, an example of the lid 230 in the second position, and an example of the canopy 215 in the second position.

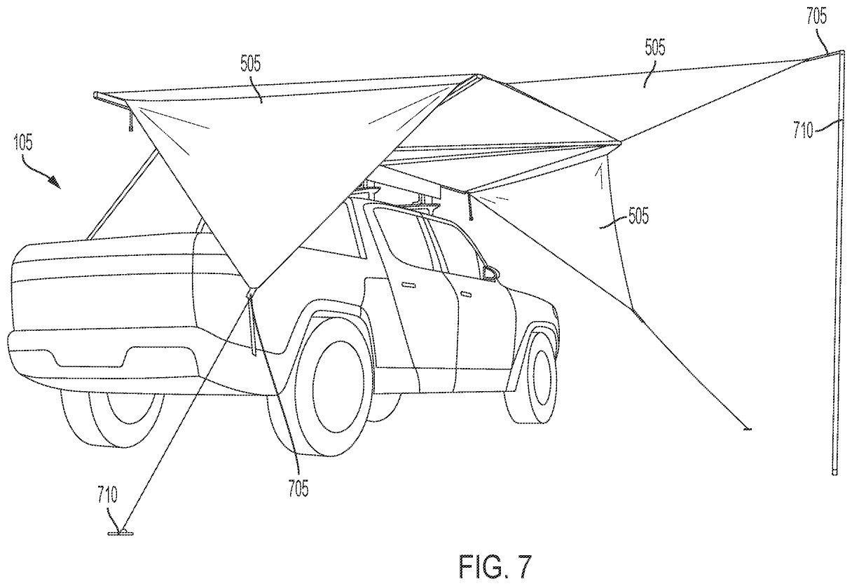

FIG. 7 depicts a rear view of the vehicle 105 including the apparatus 205, in accordance with an implementation. The configurable panels 505 can include at least one opening 705. The openings 705 can receive, obtain or otherwise accept an object 710. The openings 705 can, responsive to accepting the object 710, mount, place, secure, attach or otherwise couple the configurable panels 505 with the object 710. The object 710 can be or include at least one of a bungie cord, a bar, a beam, a pole, a rope, a stake, a strut, a stick or a post. For example, the opening 705 can accept a bungie cord (e.g., the object 710) and the bungie cord can couple the configurable panels 505 with a support structure (e.g., a ground surface, a tree, a table or a building). FIG. 7 depicts an example of a first object 710 as a cord, an example of a second object 710 as a post, an example of a first configurable panel 505 coupled with the cord (e.g., the first object 710), an example of a second configurable panel 505 coupled with the post (e.g., the second object 710), and an example of the configurable panels 505 providing an additional amount of shade.

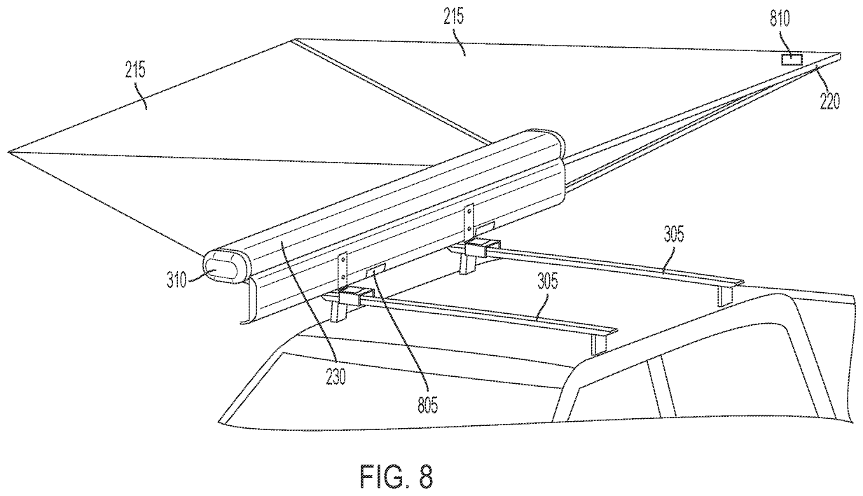

FIG. 8 depicts a perspective view of the vehicle 105 including the apparatus 205, in accordance with an implementation. The case 210 can include at least one handle 805. The handle 805 can be used to actuate a lock. The lock can, while the handle 805 is not engaged, hold, keep or otherwise maintain the lid 230 in the first position. The lock can, responsive to the handle 805 being engaged, release the lid 230 from the first position. An operator of the vehicle 105 or the apparatus 205 can interact with, interface with, engage or otherwise grab the handle 805 to actuate the lock. The canopy 215 can include at least one opening 810. The opening 810 can be at least one of located, placed, position, or otherwise orientated on a portion of the canopy 215 that is directly above or closely above the beam 220. The opening 810 can receive a fastener. For example, the opening 810 can receive a screw. The opening 810 can provide or expose at least a portion of the beam 220 that otherwise would be enclosed or covered by the canopy 215. The fastener can be inserted though the opening 810, and the fastener can mount, place, attach, secure or otherwise couple the canopy 215 with the beam 220. FIG. 8 depicts an example of the handle 805 having been used to release the lid 230 from the first position, an example of the opening 810 positioned above a portion of the beam 220, an example of the operator having placed the lid 230 in the second position, and an example of the canopy 215 having been deployed to the second position.

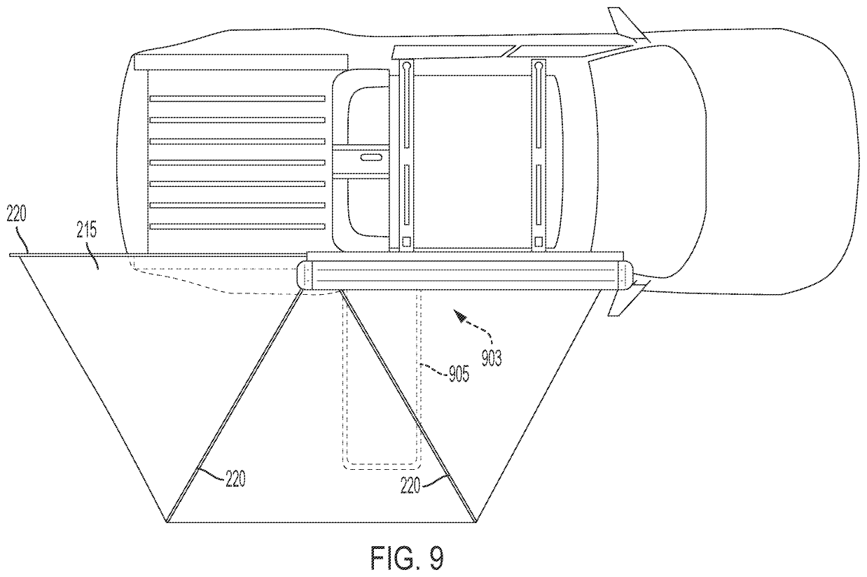

FIG. 9 depicts a top view of the vehicle 105 and the apparatus 205, in accordance with an implementation. The apparatus 205 or a portion thereof can extend beyond the vehicle 105. For example, a portion of the case 210 can extend beyond the vehicle 105. The vehicle 105 can include a gear tunnel and a gear tunnel door. The gear tunnel can house an object 905 and the gear tunnel door can support the object 905. The object 905 can be or include at least one of a table, a bench, a desk or a drawer. For example, FIG. 9 depicts the object 905 as a table. FIG. 9 depicts an example of the canopy 215 providing shade to a surrounding external area 903 that is located near the passenger side of the vehicle 105, an example of the canopy 215 providing shade to the object 905, an example of the configurable panels 505 providing additional shade to the passenger side of the vehicle 105.

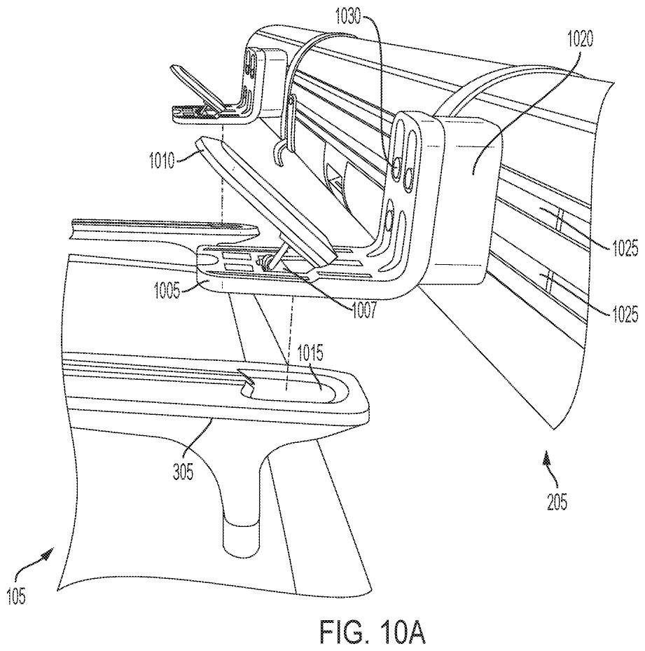

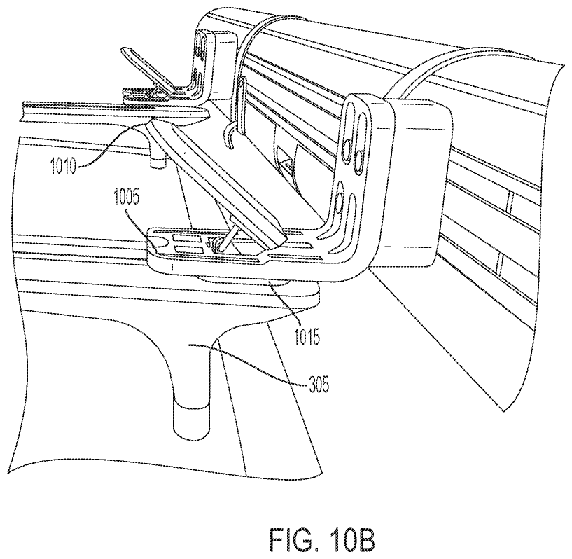

FIG. 10A depicts a rear view of the vehicle 105 receiving the apparatus 205, in accordance with an implementation. The apparatus 205 can include at least one bracket 1005, and at least one mounting module 1020. The mounting module 1020 can be mounted, placed, secured, attached or otherwise coupled with the case 210. The case 210 can include at least one railing 1025. The mounting module 1020 can be disposed or located within the railings 1025. The bracket 1005 can be mounted, placed, secured, attached or otherwise coupled, via fasteners 1030, with the mounting module 1020. The mounting module 1020 can, responsive to the fasteners 1030 coupling the bracket 1005 with the mounting module 1020, mount, place, secure, attach or otherwise couple the bracket 1005 with the case 210. The bracket 1005 can rest on, insert into or otherwise be received by the crossbars 305. For example, the bracket 1005 can rest on the crossbar 305 by placing, setting, locating or otherwise positioning the bracket 1005 on the crossbar 305. The bracket 1005 can include at least one bar 1007, and at least one latch 1010. The latch 1010 can have at least one position. For example, the latch 1010 can have at least one open position and at least one closed position. The latch 1010, while in the open position, allows for the bracket 1005 to rest on the crossbar 305, and allows for the bar 1007 to be inserted within an opening 1015 of the crossbars 305.

The opening 1015 can receive at least one of the bracket 1005 or the bar 1007. The latch 1010 can couple the bracket 1005 with the crossbar 305. The latch 1010 can couple the bracket 1005 with the crossbar 305 responsive to an operator of the vehicle 105 or the apparatus 205 moving the latch 1010 from the open position to the closed position. The moving of the latch 1010 from the open position to the closed position can move the bar 1007 from a retracted position to an extended position. The bar 1007, responsive to being moved to the extended position, can rest within the crossbar 305. For example, the bar 1007 can rest within the body of the crossbar 305. The bar 1007 can rest within the crossbar 305 by at least one of placing, locating, extending, positioning, orienting or otherwise aligning the bar 1007 within the crossbar 305. The bracket 1005 can hold, maintain or otherwise support the case 210. For example, the bracket 1005 can, responsive to the bracket 1005 being coupled with the crossbars 305, support the case 210 by maintaining the position of the case 210. FIG. 10A depicts an example of the opening 1015 receiving the bracket 1005, an example of the latch 1010 in the open position, an example of the bar 1007 in the retracted position, and an example of the apparatus 205 decoupled from the vehicle 105 or the crossbars 305.

FIG. 10B depicts a rear view of the vehicle 105 including the apparatus 205, in accordance with an implementation. FIG. 10B depicts an example of the opening 1015 having received the bracket 1005, an example of the bracket 1005 resting on the crossbars 305, an example of the mounting module 1020 having coupled the bracket 1005 with the case 210, and an example of the latch 1010 in the open position.

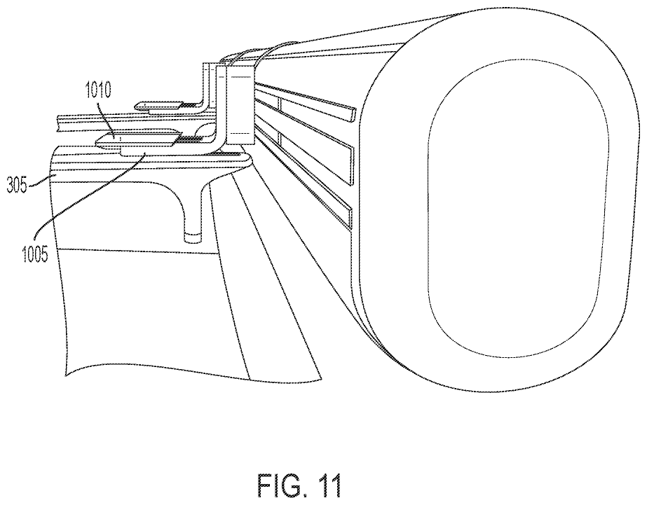

FIG. 11 depicts a rear view of the vehicle 105 and the apparatus 205, in accordance with an implementation. FIG. 11 depicts an example of the bracket 1005 resting on the crossbars 305, an example of the latch 1010 in the closed position, an example of the bracket 1005 coupled with the crossbars 305, and an example of the bracket 1005 supporting the case 210.

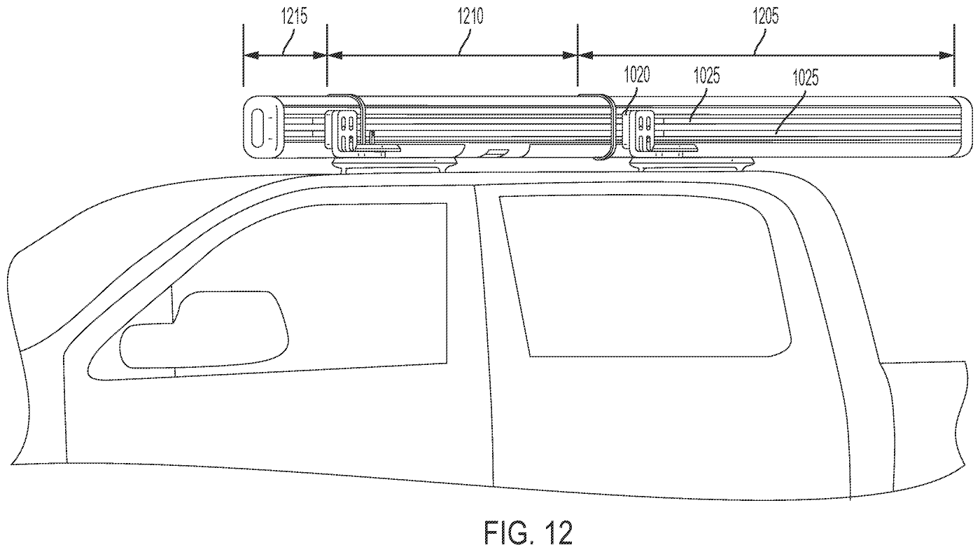

FIG. 12 depicts a side view of the vehicle 105 including the apparatus 205, in accordance with an implementation. The mounting module 1020 can slide, glide, pivot otherwise move along or within the railings 1025. The position of the case 210 with respect to the brackets 1005 can change, adjust or otherwise be modified responsive to the mounting module 1020 moving along the railings 1025. For example, a first portion of the case 210 can be positioned to the rear of the brackets 1005. The first portion of the case 210 can include a first longitudinal length and the first longitudinal length can be larger than, equal to or smaller than a second longitudinal length of a second portion of the case 210. The first longitudinal distance of the first portion of the case 210 is represented with reference number 1205. The second longitudinal distance of the second portion of the case 210 is represented with reference number 1210. A third longitudinal distance of a third portion of the case 210 is represented with reference number 1215.

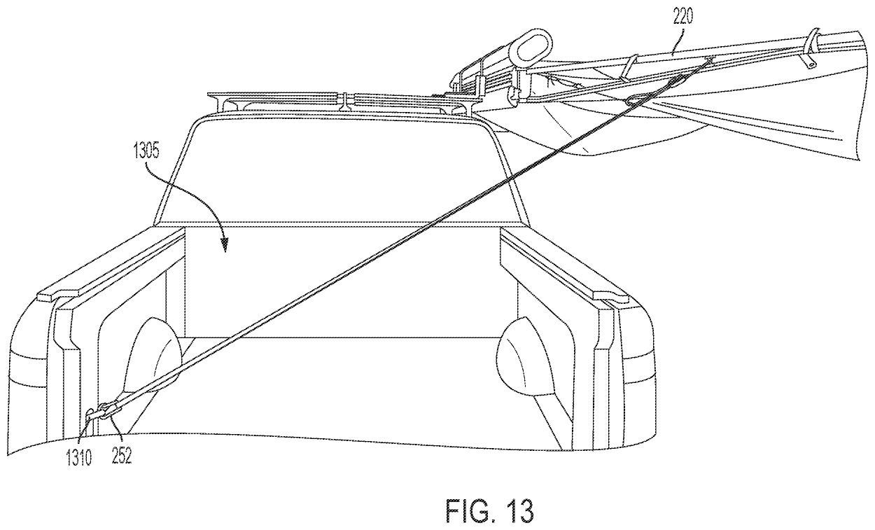

FIG. 13 depicts a rear view of the vehicle 105 including the apparatus 205, in accordance with an implementation. The vehicle 105 can include at least one cargo bed 1305. The straps 250 can be mounted, placed, secured, attached or otherwise coupled with the cargo bed 1305 or a portion thereof. The cargo bed 1305 can include at least one anchor point 1310. The anchor point 1310 can be or include at least one of a tie down anchor, a ring, a band or a loop. The anchor point 1310 can receive the straps 250 or the fastener 252. The anchor points 1310 can mount, place, secure, attach or otherwise couple the straps 250 with the cargo bed 1305 or the vehicle 105. FIG. 13 depicts the anchor point 1310 as a tie down anchor including a loop, an example of the anchor point 1310 receiving the fastener 252, an example of the straps 250 coupled with the cargo bed 1305, and an example of straps 250 supporting the beams 220 with the canopy 215 in the second position.

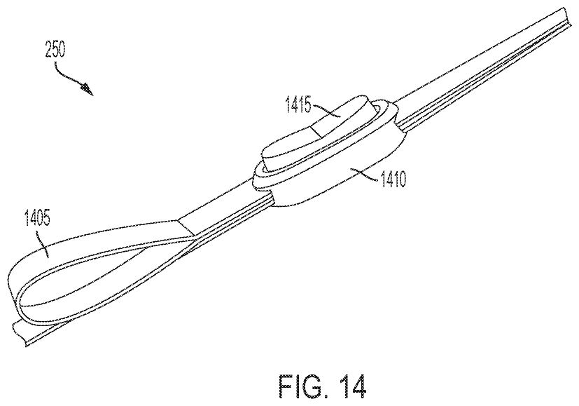

FIG. 14 depicts a top view of the straps 250, in accordance with an implementation. The straps 250 can include at least one loop 1405, at least one housing 1410, and at least one adjusting module 1415. The adjusting module 1415 can be or include at least one of a button, a toggle, a switch, a press, a lever, or a knob. The adjusting module 1415 can modify, change, alter or otherwise adjust an amount of tension that is applied on or towards the straps 250. For example, a portion of the adjusting module 1415 can make contact with, interface with or otherwise interact with the straps 250. The adjusting module 1415 making contact with the straps 250 can impact how easily an operator of the straps 250 can tighten and or loosen the straps 250. For example, the adjusting module 1415 can make contact with a first area of the straps 250 and the adjusting module 1415 can, responsive to an operator adjusting the amount of contact that the adjusting module 1415 is making with the straps 250, make contact with a second area of the straps 250. The adjusting module 1415, while making contact with the first area of the straps 250, can provide a first amount of tension to the straps 250 and the adjusting module 1415 can, while making contact with the second area of the straps 250, can provide a second amount of tension to the straps 250. An operator of the apparatus 205 or the straps 250 can interact with, interface with or otherwise engage the loop 1405 to adjust, modify or otherwise change the amount of tension or pressure that is applied to the straps 250. The amount of tension that is applied to the straps 250 can loosen and or tighten the straps 250.

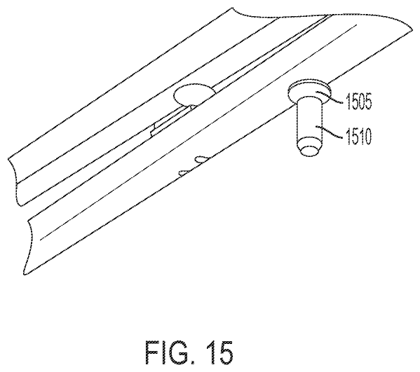

FIG. 15 depicts a bottom view of the apparatus 205, in accordance with an implementation. The apparatus 205 can include at least one plug 1505. The plug 1505 can be electrically coupled with a power source. For example, the plug 1505 can be electrically coupled with the battery 115. The plug 1505 can receive at least one cord 1510. The cord 1510 can be electrically coupled with a device. For example, the cord 1510 can be electrically coupled with a light fixture. The plug 1505 can, responsive to receiving the cord 1510, electrically couple the cord 1510 with the battery 115. The battery 115 can, responsive to being electrically coupled with the cord 1510, provide power to the device. For example, the battery 115 can provide power to the light fixture, and the light fixture can produce light responsive to receiving power from the battery 115.

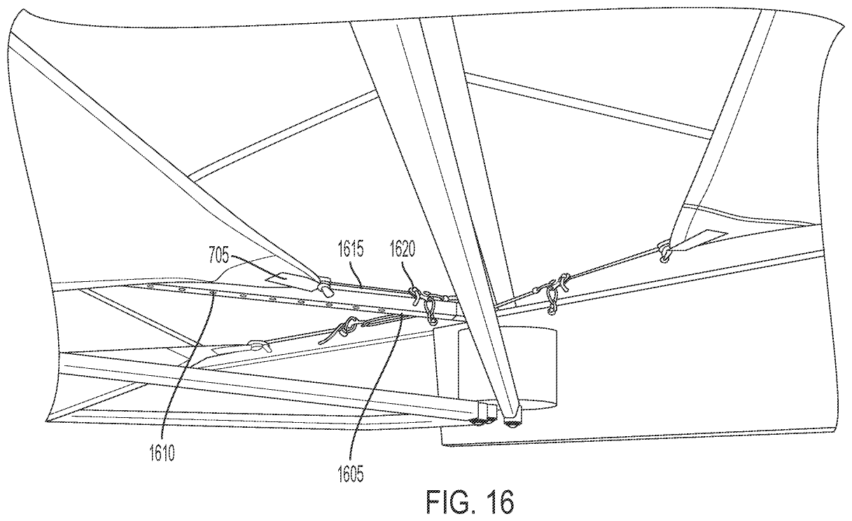

FIG. 16 depicts a bottom view of the apparatus 205, in accordance with an implementation. The apparatus 205 can include at least one light fixture 1605. The light fixture 1605 can be mounted, placed, secured, attached or otherwise coupled with the beam 220. For example, the light fixture 1605 can be coupled with the beam 220, and disposed between the canopy 215 and an object. For example, the light fixture 1605 can be disposed between the canopy 215 and a ground surface. The light fixture 1605 can include at least one light source 1610. The light source 1610 can produce light. For example, the light source 1610 can produce or emit at least one photon. The light source 1610 can be or include at least one of a Light Emitting Diode (LED), an incandescent bulb, a halogen bulb or a fluorescent bulb. The light fixture 1605 can be electrically coupled with the cord 1510. The light fixture 1605 or the light source 1610 can be electrically coupled with the battery 115.

The configurable panels 505 can include at least one cord 1615. The cord 1615 can be mounted, placed, secure, attached or coupled with the opening 705. The cord 1615 can include at least one fastener 1620. The fastener 1620 can mount, place, secure, attach or otherwise couple the cord 1615 or the configurable panels 505 with the beams 220 or the walls 225. The fastener 1620 can be or include at least one of a hook, a latch, a clasp, a lock or a clip. FIG. 16 depicts the fastener 1620 as a clip, an example of the cords 1615 coupled with the beams 220, and an example of the light source 1610 producing light

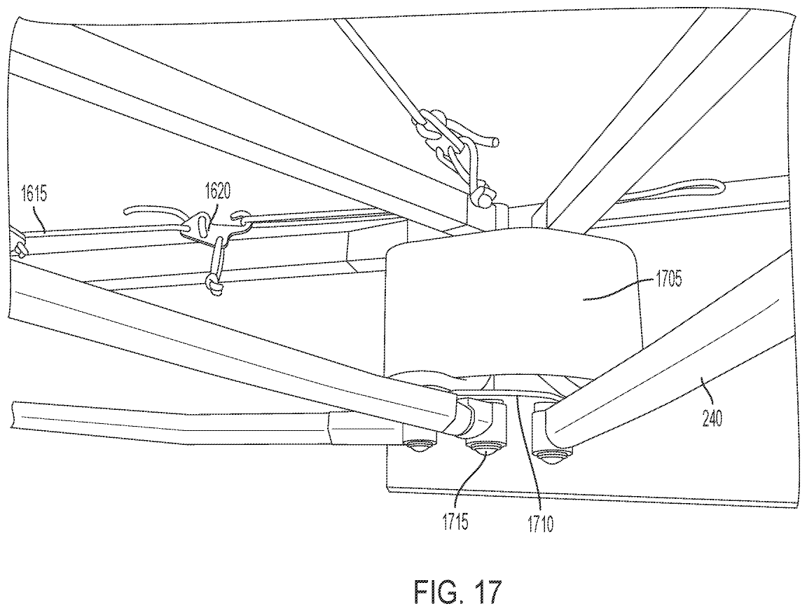

FIG. 17 depicts a front view of the wall 225, in accordance with an implementation. The apparatus 205 can include at least one enclosure 1705, and at least one plate 1710. The enclosure 1705 can be mounted, placed, secured, attached or otherwise coupled with the wall 225. The enclosure 1705 can cover at least a portion of the plate 1710. The plate 1710 can receive a fastener 1715. The fastener 1715 can be or include at least one of a bar, a clip, a bolt, or a pin. For example, the fastener 1715 can be a clevis pin. The fastener 1715 can be mounted, placed, secured, attached or otherwise coupled with the first portion 235 and the second portion 240 of the beams 220. The fastener 1715 can mount, place, secure, attach or otherwise couple the beams 220 with the plate 1710. The plate 1710 can couple the beams 220 with the wall 225. The beams 220 can, responsive to being coupled with the plate 1710, move, swivel, hinge, adjust or otherwise swing separate to the case 210. For example, a proximal end of the beams 220 can be coupled, via the plate 1710, with the wall 225, and a distal end of the beams 220 can swivel while the proximal end of the beams 220 are coupled with the wall 225. FIG. 17 depicts an example of the enclosure 1705 covering the plate 1710, and an example of the fastener 1715 coupled with the first portion 235 and the second portion 240.

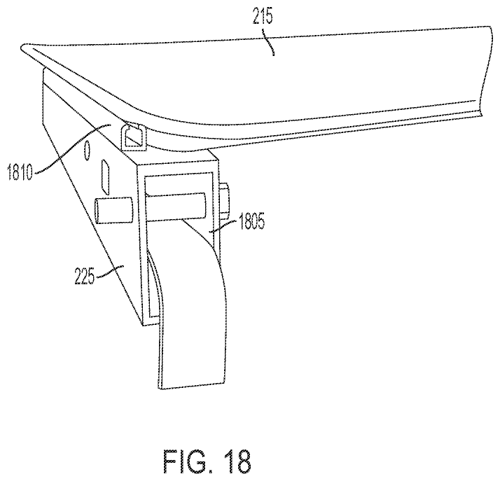

FIG. 18 depicts a side view of the apparatus 205. The end caps 310 of the apparatus 205 have been removed resulting in a spine 1805 disposed within the wall 225 becoming visible. The wall 225 can include at least one slot 1810. The slot 1810 can receive the canopy 215 and the canopy 215 can be mounted, placed, secured, attached, or otherwise coupled with, via the slots 1810, with the wall 225. The slots 1810 can be or include keder slots.

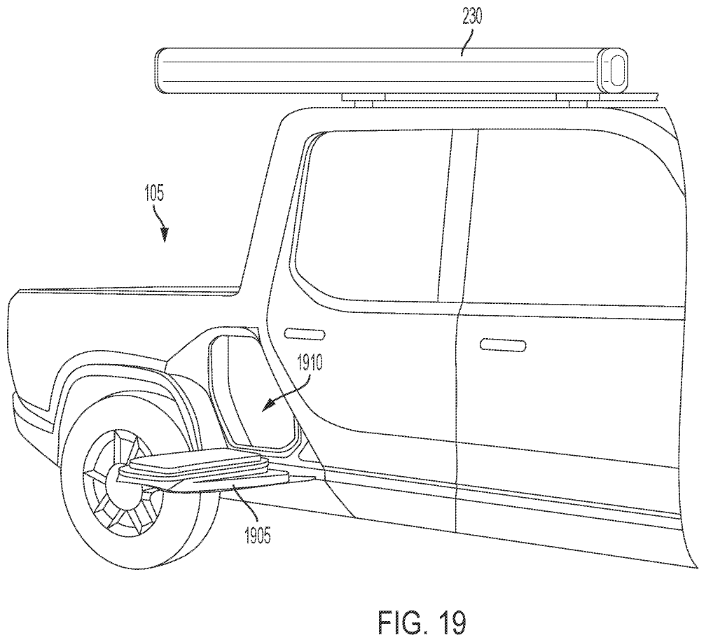

FIG. 19 depicts a side view of the vehicle 105 including the apparatus 205, in accordance with an implementation. The vehicle 105 can include at least one gear tunnel door 1905 and at least one gear tunnel 1910. The gear tunnel door 1905 can move between open and closed positions sealing or exposing an interior of the gear tunnel 1910. The gear tunnel door 1905 can hinge on a bottom side, a top side, or a lateral side. The gear tunnel door 1905 can be structured to support an object. The canopy 215 can, responsive to being deployed from within the case 210, provide shade or shelter to the gear tunnel door and the area located near the gear tunnel door 1905. FIG. 19 depicts an example of the lid 230 in the first position, an example of the canopy 215 stowed within the case 210, an example of the gear tunnel door 1905 in the open position, and an example of the gear tunnel door 1905 exposing a portion of the gear tunnel 1910.

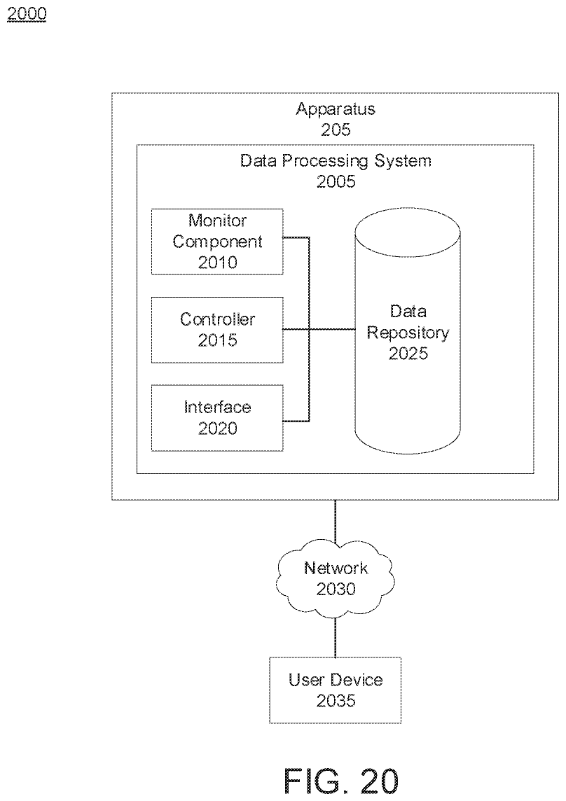

FIG. 20 depicts a system 2000 to control an apparatus, in accordance with an implementation. The apparatus can be the apparatus 205. The apparatus 205 can be included with or coupled with the vehicle 105. The system 2000 can include the apparatus 205, at least one network 2030 and at least one user device 2035. The apparatus 205 can include at least one data processing system 2005. The data processing system 2005 can include at least one monitor component 2010, at least one controller 2015, at least one interface 2020 and at least one data repository 2025. The data processing system 2005 or at least one component of the data processing system 2005 can be external to the apparatus 205. For example, the data processing system 2005 can be a remote server system (e.g., a cloud based data processing system), included in the vehicle 105 (e.g., included in the infotainment system of the vehicle 105), or a data processing system that is included in or stored on a user device (e.g., the user device 2035).

The monitor component 2010 can be or include at least one motion sensor. The motion sensor can collect data. The motion sensor collect data that can be used to determine the position of the canopy 215. For example, the motion sensor can detect when the canopy 215 moves from the first position to the second position or when the canopy 215 moves from the second position to the first position.

The monitor component 2010 can be or include at least one interface sensor. The interface sensor can collect data that can be used to determine a selection on an interface. For example, the interface sensor can be a tactile sensor. The interface sensor can detect an operator of the apparatus 205 or the vehicle 105 selecting at least one option presented on a user interface. For example, an operator can select an option on a user interface, displayed by the interface 2020, to stow the canopy 215 in the first position and the interface sensor can detect that the option to stow the canopy 215 in the first position has been selected.

The interface 2020 can be or include at least one of a display device, a display screen, a monitor, an infotainment system of the vehicle 105 or a user device. The interface 2020 can display, provide, create, generate or otherwise present at least one user interface or at least one graphical user interface. The graphical user interface, presented by the interface 2020, can include at least one icon. For example, the interface can include a stow canopy icon.

The data processing system 2005 and the user device 2035 can interface by using the network 2030. The user device 2035 can include at least one of a mobile phone, a smart watch, a tablet, a smart phone, an infotainment system of a vehicle (e.g., the infotainment system of the vehicle 105). An operator of the user device 2035 can perform similar operations to that performed by selecting icons on the interface 2020. For example, the user device 2035 can include an application that has been stored on the user device 2035 and is associated with the apparatus 205. For example, when an operator purchased the apparatus 205 or the vehicle 105 they received instructions of how to download the application and link the application with the apparatus 205 or the vehicle 105. An operator of the user device 2035 can select an icon on an interface of the user device 2035 to stow the canopy 215 in the first position.

The data repository 2025 can include, store, maintain or otherwise provide data. The data can be data that is collected and provided by the monitor component 2010, data that is collected and provided by the interface 2020 or data that is provided by the user device 2035.

The monitor component 2010 can receive, via the interface 2070, an indication (e.g., a first indication) to stow the canopy 215 in the first position. The indication can be an operator of the vehicle 105, the user device 2035, or the apparatus 205 selecting an icon, displayed by the interface 2070, to stow the canopy 215 in the first position.

The monitor component 2010 can, responsive to receiving the indication to stow the canopy in the first position, communicate with, interface with or otherwise interact with the controller 2015. The controller 2015 can receive, from the monitor component 2010, the indication to stow the canopy 215. The controller 2015 can be mounted, attached, placed, secured or coupled with the apparatus 205 or a component thereof. For example, the controller 2015 can be coupled with the beams 220. The controller 2015 can be or include at least one of a motor, a piston, a hydraulic or an actuator. The controller 2015 can, responsive to receiving the indication to stow the canopy 215, stow the canopy 215 by moving the beams 220 from a position external the case 210 to a position within the case 210.

The monitor component 2010 can receive, via the interface 2070, a second indication to deploy the canopy 215 to the second position. The indication can be an operator of the vehicle 105, the user device 2035, or the apparatus 205 selecting an icon, displayed by the interface 2070, to deploy the canopy 215 to the second position.

The monitor component 2010 can, responsive to receiving the indication to deploy the canopy to the second position, communicate with, interface with or otherwise interact with the controller 2015. The controller 2015 can receive, from the monitor component 2010, the indication to deploy the canopy 215. The controller 2015 can, responsive to receiving the indication to deploy the canopy 215, deploy the canopy 215 by moving the beams 220 from the position within the case 210 to a position external to the case 210.

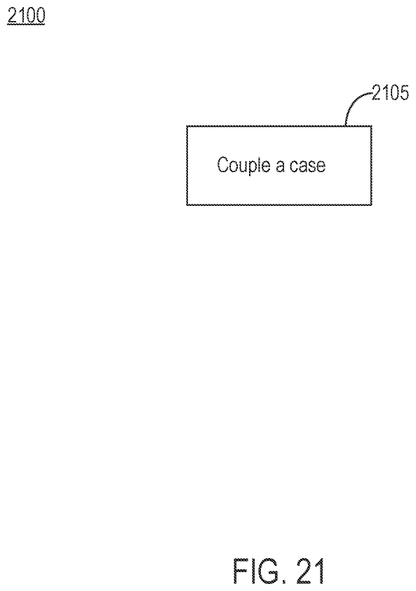

FIG. 21 depicts an example flow diagram of a process 2100 of manufacturing an apparatus, in accordance with an implementation. The apparatus can be the apparatus 205. In ACT 2105, a case can be coupled. The case can be the case 210. The case 210 can be coupled with the beam 220. The case can be coupled with the beam 220 by mounting, attaching, placing or otherwise securing the case 210 with the beam 220. For example, the case 210 can be coupled with the beam 220 responsive to the fastener 1715 coupling the beam 220 with the plate 1710. The plate 1710 can, responsive to coupling with the beam 220, couple the case 210 with the beam 220. The case 210 can couple with a crossbar. For example, the case 210 can couple with the crossbar 205. The case 210 can also stow a canopy. For example, the case 210 can stow the canopy 215. The beam 220 can deploy a canopy. For example, the beam 220 can deploy the canopy 215 to a positon that is external to the case 210.

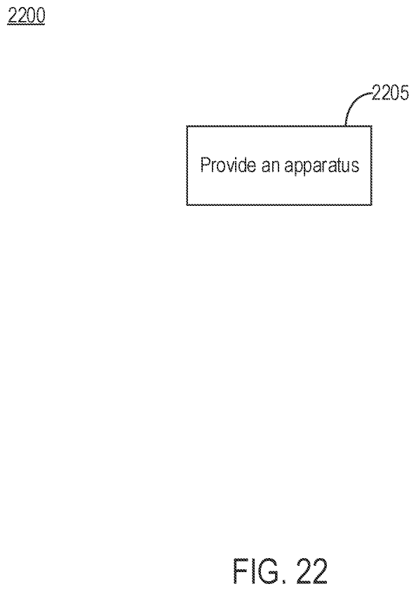

FIG. 22 is a flow diagram of a process 2200 where an apparatus can be provided. In ACT 2205, an apparatus can be provided. The apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a case (e.g., the case 210), a canopy (e.g., the canopy 215), a beam (e.g., the beam 220), and a wall (e.g., the wall 225).

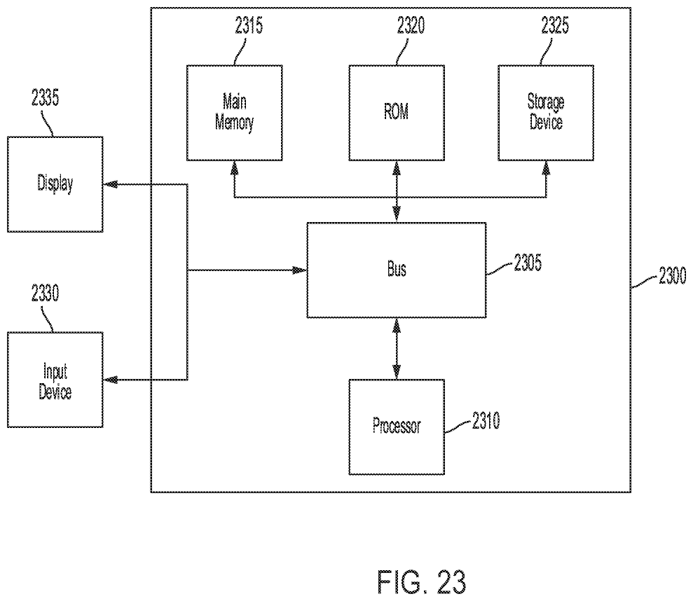

FIG. 23 depicts an example block diagram of an example computer system 2300. The computer system or computing device 2300 can include or be used to implement a data processing system or its components. The computing system 2300 includes at least one bus 2305 or other communication component for communicating information and at least one processor 2310 or processing circuit coupled to the bus 2305 for processing information. The computing system 2300 can also include one or more processors 2310 or processing circuits coupled to the bus for processing information. The computing system 2300 also includes at least one main memory 2315, such as a random access memory (RAM) or other dynamic storage device, coupled to the bus 2305 for storing information, and instructions to be executed by the processor 2310. The main memory 2315 can be used for storing information during execution of instructions by the processor 2310. The computing system 2300 may further include at least one read only memory (ROM) 2320 or other static storage device coupled to the bus 2305 for storing static information and instructions for the processor 2310. A storage device 2325, such as a solid state device, magnetic disk or optical disk, can be coupled to the bus 2305 to persistently store information and instructions.

The computing system 2300 may be coupled via the bus 2305 to a display 2335, such as a liquid crystal display, or active matrix display, for displaying information to a user such as a driver of the electric vehicle 105 or other end user. An input device 2330, such as a keyboard or voice interface may be coupled to the bus 2305 for communicating information and commands to the processor 2310. The input device 2330 can include a touch screen display 2335. The input device 2330 can also include a cursor control, such as a mouse, a trackball, or cursor direction keys, for communicating direction information and command selections to the processor 2310 and for controlling cursor movement on the display 2335.

The processes, systems and methods described herein can be implemented by the computing system 2300 in response to the processor 2310 executing an arrangement of instructions contained in main memory 2315. Such instructions can be read into main memory 2315 from another computer-readable medium, such as the storage device 2325. Execution of the arrangement of instructions contained in main memory 2315 causes the computing system 2300 to perform the illustrative processes described herein. One or more processors in a multi-processing arrangement may also be employed to execute the instructions contained in main memory 2315. Hard-wired circuitry can be used in place of or in combination with software instructions together with the systems and methods described herein. Systems and methods described herein are not limited to any specific combination of hardware circuitry and software.

Although an example computing system has been described in FIG. 23, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a case configured to stow a canopy, and the case configured to couple with a crossbar; and
a beam coupled with the case, and the beam configured to deploy the canopy.

2. The apparatus of claim 1, comprising:
a bracket, coupled with the case, the bracket configured to rest on the crossbar of a vehicle, and the bracket configured to support the case; and
the bracket comprises:
a bar configured to rest within the crossbar of the vehicle; and
a latch configured to couple the bracket with the crossbar.

3. The apparatus of claim 1, wherein:
the canopy comprises:
an opening configured to receive a fastener; and
the fastener configured to couple the canopy with the beam.

4. The apparatus of claim 1, comprising:
the case including:
a lid configured to enclose the canopy and the lid configured to provide access to the canopy; and
a handle configured to move the lid from a first position to a second position;
wherein the lid encloses the canopy with the lid in the first position, and wherein the lid provides access to the canopy with the lid in the second position.

5. The apparatus of claim 1, comprising:
an enclosure, coupled with a wall of the case, the enclosure configured to cover, and couple with a plate; and
the plate configured to receive a fastener, wherein the fastener is configured to couple with a first portion and a second portion of the beam.

6. The apparatus of claim 1, comprising:
a light fixture coupled with the beam, the light fixture including a light source; and
the light source configured to produce light, and the light source configured to electrically couple with a battery of a vehicle.

7. The apparatus of claim 1, comprising:
the beam configured to deploy the canopy to a position external to the case;
the canopy including a configurable panel; and
the configurable panel configured to move from the position external to the case to a second position external to the case.

8. The apparatus of claim 1, comprising:
a strap coupled with the beam; and
the strap configured to couple with a vehicle, and the strap configured to support the beam with the canopy in a position external to the case.

9. The apparatus of claim 1, comprising:
a data processing system, the data processing system comprising at least one processor, coupled with memory, to:
receive, via a graphical user interface, a first indication to stow the canopy in a first position;
stow, responsive to the first indication, the canopy in the first position;
receive, via the graphical user interface, a second indication to deploy the canopy to a second position; and
deploy, responsive to the second indication, the canopy to the second position.

10. The apparatus of claim 1, comprising:
the beam configured to deploy the canopy to a position external to the case; and
the beam configured to support the canopy in the position external to the case.

11. A vehicle, comprising:
a crossbar; and
an apparatus, the apparatus including:
a case configured to stow a canopy, and the case configured to couple with the crossbar; and
a beam coupled with the case, and the beam configured to deploy the canopy.

12. The vehicle of claim 11, comprising:
the crossbar including:
an opening, the opening configured to receive a bracket of the apparatus; and
the bracket comprises:
a bar configured to rest within the crossbar; and
a latch configured to couple the bracket with the crossbar.

13. The vehicle of claim 11, wherein:
the canopy comprises:
an opening configured to receive a fastener; and
the fastener configured to couple the canopy with the beam.

14. The vehicle of claim 11, comprising:
the case including:
a lid configured to enclose the canopy and the lid configured to provide access to the canopy; and
a handle configured to move the lid from a first position to a second position;
wherein the lid encloses the canopy with the lid in the first position, and wherein the lid provides access to the canopy with the lid in the second position.

15. The vehicle of claim 11, comprising:
the apparatus including a light fixture, the light fixture coupled with the beam, and the light fixture including a light source; and
the light source configured to produce light, and the light source configured to electrically couple with a battery of the vehicle.

16. The vehicle of claim 11, comprising:
the beam configured to deploy the canopy to a position external to the case;
the canopy including a configurable panel; and
the configurable panel configured to move from the position external to the case to a second position external to the case.

17. The vehicle of claim 11, comprising:
the beam configured to deploy the canopy to a position external to the case; and
the beam configured to support the canopy in the position external to the case.

18. A method of manufacturing an apparatus, the method comprising:
coupling a case with a beam, the case configured to stow a canopy, and the case configured to couple with a crossbar, and the beam configured to deploy the canopy.

19. The method of claim 18, comprising:
coupling a bracket with the case, the bracket configured to rest on the crossbar of a vehicle, and the bracket configured to support the case; and
the bracket comprises:
a bar configured to rest within the crossbar of the vehicle; and
a latch configured to couple the bracket with the crossbar of the vehicle.

20. The method of claim 18, comprising:
coupling a strap with the beam, the strap configured to couple with a vehicle, and the strap configured to support the beam with the canopy in a position external to the case.
